(19) United States
(12) Patent Application Publication
(10) Pub. No.: US 2002/0136013 A1
(43) Pub. Date: Sep. 26, 2002

(54) Light board retaining ring

(76) Inventor: Paul D. Crunk, Taylor, MI (US)

Correspondence Address: PAUL D. CRUNK, TRACK MASTER INC., MFG, P.O. BOX 725, TAYLOR, MI, 48180, US

(21) Appl. No.: 09/813,260

(22) Filed: Mar. 20, 2001

(51) Int. Cl. F21V 19/00

(52) U.S. Cl. 362/362; 362/249; 362/310

(57) ABSTRACT

A light assembly has a housing with a circuit board and illumination element in the housing. A retainer secures the circuit board and illumination element in the housing. The retainer includes a first portion surrounding the circuit board. A second member applies a force on the circuit board to position the circuit board in the housing. A third member secures the retainer with the housing to maintain the retainer on the housing. A lens is coupled with the housing to cover the illumination elements.

### FIELD OF THE INVENTION

The present invention relates to vehicle lighting and, more particularly, to vehicle lamps which include retainers to secure boards in the lamp housing.

### BACKGROUND OF THE INVENTION

In particularly large trucks and tractor-trailer trucks utilize numerous lights to illuminate the truck as well as the trailer. At the rear of the truck or trailer, a plurality of lights are positioned about the periphery of the trailer or the truck in order to illuminate the vehicle. Also, several of the lights may be utilized as brake lights as well as running lights.

The lights generally include a housing with a circuit board and an illumination element in the housing, as well as a lens covering the illumination element. It has been found that as the trucks and trailers are driven across the highway, that vibration is created in the truck and trailer which in turn vibrates the lights. As the lights vibrate, there is a possibility that the circuit board, as well as the illuminating elements, may be separated from the housing. As this occurs, and as vibration continues, the lights ultimately fail. Thus, the lights must be replaced before its useful lifetime has been utilized.

### SUMMARY OF THE INVENTION

The present invention provides the art with a light which retains the circuit board in position when the light is subject to vibration. The present invention provides a retainer which maintains the circuit board and illumination element in place within the housing. The present invention provides an efficient cost-effective retainer which increases the lifetime of the lamps.

From the following detailed description, taken in conjunction with the drawings and subjoined claims, other objects and advantages of the present invention will become apparent to those skilled in the art.

### BRIEF DESCRIPTION OF THE DRAWINGS

The present invention will become more fully understood from the detailed description and the accompanying drawings, wherein:

FIG. 1 is a perspective view of a lamp assembly in accordance with the present invention.

FIG. 2 is a cross-section view of FIG. 1 along line 2-2 thereof.

FIG. 3 is an exploded perspective view of the light of FIG. 1.

FIG. 4 is a cross-section view of another embodiment of the present invention.

FIG. 5 is a cross-section view of an alternate embodiment of the present invention.

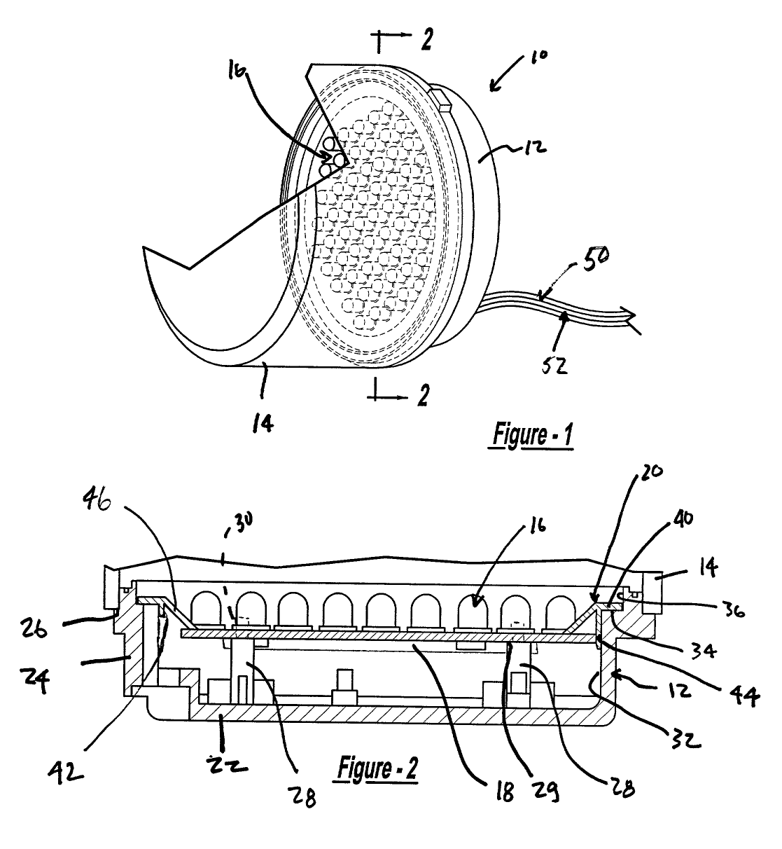

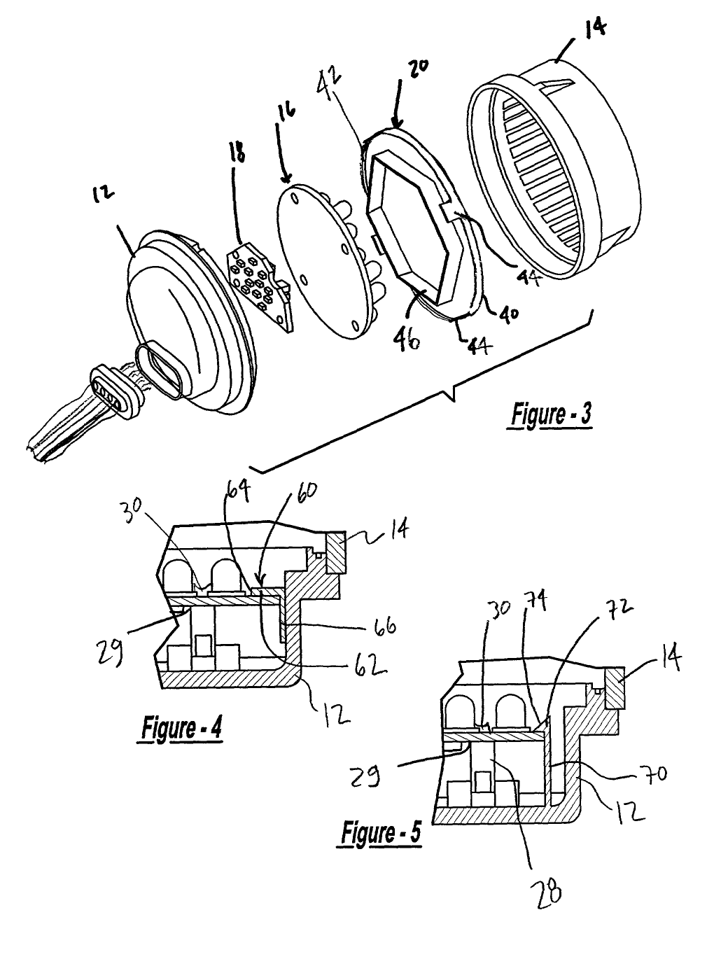

### DETAILED DESCRIPTION OF THE PREFERRED EMBODIMENTS

Turning to the figures, a lamp assembly is illustrated and designated with the reference numeral 10. The lamp assembly includes a housing 12, lens 14, illumination element 16, and circuit board 18. A retainer 20 maintains the illumination element and circuit board in position.

The lens 14 has an overall cylindrical shape with a dimensioned circumference to be fitted onto the housing 12. The lens 14 may be ultrasonically welded, adhered, or the like to the housing 12.

The housing 12 has an overall cylindrical cup-shape with a base 22 and an extending wall 24. The extending wall 24 includes a flange 26 which provides a stop as well as a securement surface for the lens 14. The base 22 includes a plurality of extending posts 28. The posts receive the circuit board 18 and illumination member 16. The posts 28 include a tip portion 30 which is ultrasonically welded to retain the circuit board 18 and illumination member 16 to the housing 12. The housing wall 24 includes an internal surface 32. The surface 32 includes a step portion 34 and a ring portion 36 extending from the step portion 34.

The circuit board 18 as well as the illumination member 16 include bores which are sized so that the post tip 30 fits into the bores. After the circuit board and illumination member are positioned onto the post 28, they rest on a post shoulder 29 so that once the tip 30 is ultrasonically welded, the tip 30 expands securing the circuit board as well as the illumination member to the housing. A circumferential gap is formed between the illumination member 16, circuit board 18 and the housing wall 24.

The retaining ring 20 is positioned onto the step portion 34 of the internal housing surface 32. The retaining member 20 includes a first ring member 40 which is positioned on top of the step 34. An extending flange 42 extends perpendicular to the first ring portion 40. The flange 42 is ring-shaped and fits in the gap between the illumination member and circuit board and the housing surface 32. The flange 42 may include fingers 44 which extend further than the flange 42 so that the fingers 44 contact the illuminating element 16 to reduce the lateral movement of the illumination element 16 in the housing 12. The retainer 20 includes an angled skirt 46 which extends from the ring 40. The skirt 46 rests on the illuminating element 16. The skirt 46 acts as a biasing member applying force onto the illumination element 16 to maintain it in position on the posts. The ring 40 is ultrasonically welded, or the like, to the housing step 34. Once this occurs, the retainer 20 is fixed in place, applying force onto the illumination element 16. The force of the ring, as vibration occurs, maintains the illumination element 16 on the housing, eliminating premature failure of the light.

Also, the light includes a pigtail connector 50 which includes a plurality of wires 52. The wires 52 are coupled with the circuit board 18. The other ends of the wires are coupled with a power source from the vehicle.

Turning to FIG. 4, a second embodiment of the invention is shown. Here, an alternate retainer is illustrated. The retainer 60 has an inverted cup shape with a cut-out in the base 62. The cut out 64 surrounds the illumination element 16. The wall 66 extends from the base 62 towards the base of the housing 12. The walls 66 are ultrasonically welded to the housing wall 24.

Turning to FIG. 5, an additional embodiment is shown. Here, the housing 12 includes a plurality of extending barbs 70. The barbs have heads 72 with an angled surface 74. The angled surface allows the illumination element 16 to spread the barbs 70 to enable the illumination element 16 to slide under the heads 72 wherein the barbs 70 spring back to retain the illumination element 16 under the heads 72.

While the above detailed description describes the preferred embodiment of the present invention, the invention is susceptible to modification, variation and alteration without deviating from the scope and fair meaning of the subjoined claims.

What is claimed is:

1. A light comprising:
a housing;
a retainer for securing said circuit board in said housing, said retainer including a first member for surrounding said circuit board, a second member for applying a force on said circuit board to position said circuit board in said housing, and a third member for securing with said housing for maintaining said retainer on said housing;
an illumination element coupled with said circuit board; and
a lens coupled with said housing.

2. The light according to claim 1, wherein said third member is ultrasonically welded with said housing.

3. The light according to claim 1, wherein said retainer includes a fourth member circumferentially positioned about said circuit board and between said circuit board and said housing.

4. The light according to claim 1, wherein said retainer first member is ring-shaped either circular or polygonal.

5. The light according to claim 4, wherein said second member is continuous with said first member.
